(19) United States
(12) Patent Application Publication
(10) Pub. No.: US 2018/0267583 A1
(43) Pub. Date: Sep. 20, 2018

(54) POWER SUPPLY RELAY UNIT

(71) Applicant: FUJI ELECTRIC CO., LTD., Kawasaki-shi (JP)

(72) Inventor: Shinji HATAKENAKA, Suzuka-shi (JP)

(21) Appl. No.: 15/987,417

(22) Filed: May 23, 2018

Related U.S. Application Data
(63) Continuation of application No. PCT/JP2017/001259, filed on Jan. 16, 2017.

(30) Foreign Application Priority Data
Jun. 7, 2016 (JP) 2016-113260

(51) Int. Cl. G06F 1/26; H02J 7/02

(52) U.S. Cl. CPC G06F 1/26; H02J 7/02

(57) ABSTRACT

In the power supply relay unit, a controller is configured to return preset dummy information on AC input power to a load in response to a request signal from the load for requesting information on the AC input power.

### CROSS-REFERENCE TO RELATED APPLICATION

This application is a continuation of PCT application PCT/JP2017/001259, filed on Jan. 16, 2017, which is based upon and claims priority of Japanese patent application No. 2016-113260, filed on Jun. 7, 2016, the entire contents of which are incorporated herein by reference.

### BACKGROUND OF THE INVENTION

### Field of the Invention

The present invention relates to a power supply relay unit, and more particularly, it relates to a power supply relay unit provided between a power supply and a load.

### Description of the Background Art

In general, a power supply unit provided between a power supply and a load is known. Such a power supply unit is disclosed in International Publication No. WO2011/135712.

International Publication No. WO2011/135712 discloses a server system including a power supply unit and a blade server. In this server system, the power supply unit includes an AC-DC converter and a DC-DC converter. AC power from an AC power supply (commercial power supply) is converted into DC power by the AC-DC converter, and the DC power obtained by conversion by the AC-DC converter is stepped down by the DC-DC converter. The DC power stepped down by the DC-DC converter is supplied to the blade server.

In a configuration (AC server) in which AC power (commercial power supply) is input to a server system as in International Publication No. WO2011/135712, an input voltage value becomes relatively high as compared with a configuration in which DC power is directly input to a server system. Thus, maintenance of the server system is disadvantageously relatively difficult. Furthermore, in the configuration in which AC power is supplied, a circuit configuration is relatively complicated as compared with the configuration in which DC power is supplied, and hence the reliability becomes disadvantageously relatively low.

Therefore, in order to solve these disadvantages, a configuration has been proposed in which a DC power supply is disposed between an AC power supply and a server system, and DC power is input to an existing server system (AC server). That is, it has been proposed that the existing AC server is caused to function as a DC server. In this configuration in which the existing AC server is caused to function as the DC server, DC power is input to the server system, and hence a power supply unit that converts AC power into DC power is not provided.

However, in the conventional server system (AC server) as disclosed in International Publication No. WO2011/135712, the blade server (load) of the server system may request information on AC input power from the power supply unit. In this case, in the configuration in which the existing AC server is caused to function as the DC server, a power supply unit (power supply unit to which AC power is input) is not provided, and hence there is a problem that the blade server stops due to failure to obtain appropriate information on the AC input power from the power supply unit.

### SUMMARY OF THE INVENTION

The present invention has been proposed in order to solve the aforementioned problem, and one object of the present invention is to provide a power supply relay unit capable of suppressing stop of a load in a configuration in which an existing load to which an alternating current is input is caused to function as a load to which a direct current is input.

In order to attain the aforementioned object, a power supply relay unit according to an aspect of the present invention is provided between a DC power supply including a power supply unit that converts AC power into DC power and a battery unit that stores the DC power obtained by conversion by the power supply unit, and a load, and includes a switch to which the DC power from the DC power supply is input and a controller that controls whether the switch is on or off so as to supply the DC power from the DC power supply to the load. The controller is configured to return preset dummy information on AC input power to the load in response to a request signal from the load for requesting information on the AC input power.

In the power supply relay unit according to this aspect of the present invention, as hereinabove described, the controller is configured to return the preset dummy information on the AC input power in response to the request signal from the load for requesting the information on the AC input power. Thus, even when the load requests the information on the AC input power from the power supply relay unit, the preset dummy information on the AC input power is returned from the power supply relay unit, and hence it is possible to suppress stop of the load due to failure to obtain the appropriate information on the AC input power. Consequently, it is possible to suppress stop of the load in a configuration in which an existing load to which an alternating current is input is caused to function as a load to which a direct current is input.

In the aforementioned power supply relay unit according to this aspect, the controller is preferably configured to return the preset dummy information on the AC input power to the load in response to the request signal, based on a predetermined standard for managing a power supply, from the load for requesting the information on the AC input power. According to this configuration, when the load operates based on the predetermined standard for managing a power supply, the existing load to which an alternating current is input can be caused to function as the load to which a direct current is input without separately, newly creating a configuration (software) for communicating (exchanging signals) between the load and the power supply relay unit.

In the aforementioned power supply relay unit according to this aspect, the dummy information on the AC input power is preferably information on a voltage value of the AC power. According to this configuration, the information on the voltage value of the AC power is returned to the load, and hence the load determines that appropriate AC power is input. Consequently, it is possible to suppress stop of the load.

The aforementioned power supply relay unit according to this aspect preferably further includes a power supply relay unit-side connection directly connected to a load-side connection included in the load and connectable to a load-side power supply unit that converts AC power into DC power. According this configuration, instead of the load-side power supply unit that converts AC power into DC power, the power supply relay unit can be connected, and hence the power supply relay unit can receive the request signal from the load, which the load-side power supply unit would receive if the load-side power supply unit was connected to the load-side connection.

In this case, the power supply relay unit-side connection is preferably directly connected to the load-side connection included in a server as the load and connectable to the load-side power supply unit. According to this configuration, the power supply relay unit can receive the request signal (a signal for making a request when the server is driven) from the server, which the load-side power supply unit would receive if the load-side power supply unit was connected to the load-side connection.

The aforementioned power supply relay unit including the power supply relay unit-side connection preferably further includes a power supply relay unit main body, and the power supply relay unit main body is preferably disposed in a storage capable of housing the load-side power supply unit of the load in a state where the power supply relay unit-side connection is directly connected to the load-side connection. According to this configuration, the power supply relay unit is disposed in the storage capable of housing the load-side power supply unit and provided in advance in the load, and hence it is not necessary to separately provide a space for disposing the power supply relay unit. Consequently, it is possible to suppress an increase in the size of a system including the power supply relay units and the load.

In the aforementioned power supply relay unit according to this aspect, the switch preferably includes a first switch turned on to supply a first current to the load and activate a load-side controller of the load, and a second switch turned on based on a request signal for requesting power supply from the load-side controller of the load, after the load-side controller of the load is activated, to supply a second current larger than the first current to the load and drive the load. According to this configuration, after the load-side controller of the load is activated by the first current, preparation of the load is completed, and thereafter the load can be driven by the second current. Therefore, it is possible to suppress driving of the load in a state where preparation of the load is not completed.

In the aforementioned power supply relay unit according to this aspect, a plurality of the power supply relay units is preferably provided so as to correspond to a plurality of the loads. According to this configuration, the dummy information on the AC input power can be returned from each of the plurality of power supply relay units in response to the request signal from each of the plurality of loads.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of server systems (DC power supplies, power supply relay units, servers) according to an embodiment of the present invention;

FIG. 2 is a diagram showing a server system disposed in a server rack;

FIG. 3 is a block diagram of a power supply relay unit according to the embodiment of the present invention;

FIG. 4 is a diagram showing examples of a command for communication in the PMBus standard;

FIG. 5 is an exploded perspective view of the power supply relay unit according to the embodiment of the present invention; and

FIG. 6 is a block diagram of a power supply relay unit according to a modification of the embodiment of the present invention.

### DESCRIPTION OF THE PREFERRED EMBODIMENTS

An embodiment embodying the present invention is hereinafter described on the basis of the drawings.

### Present Embodiment

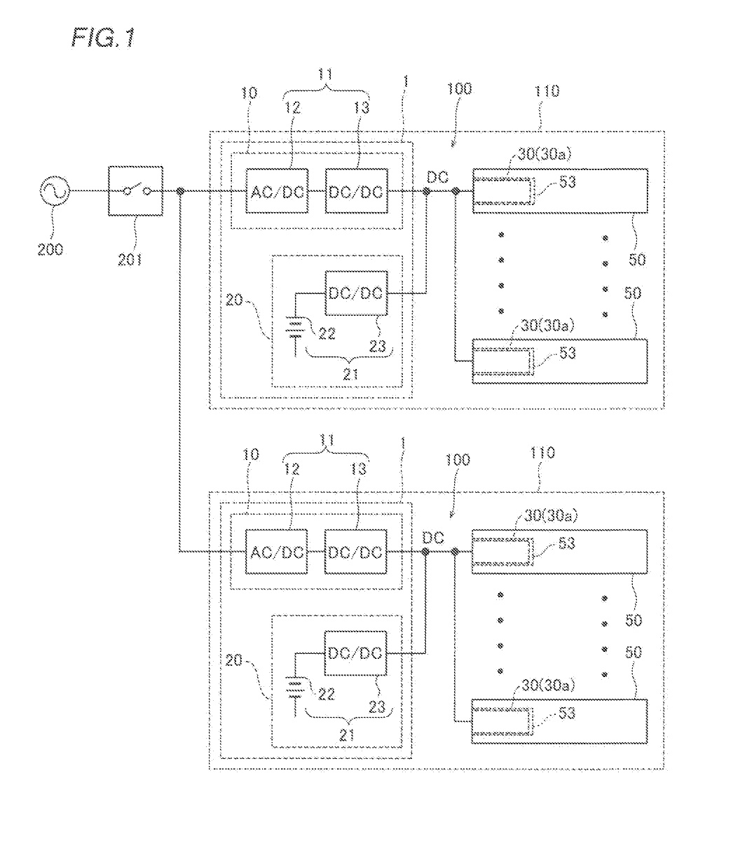

The configuration of a DC power supply system 100 (power supply relay units 30) according to the present embodiment is described with reference to FIGS. 1 to 5.

(Configuration of DC Power Supply System)

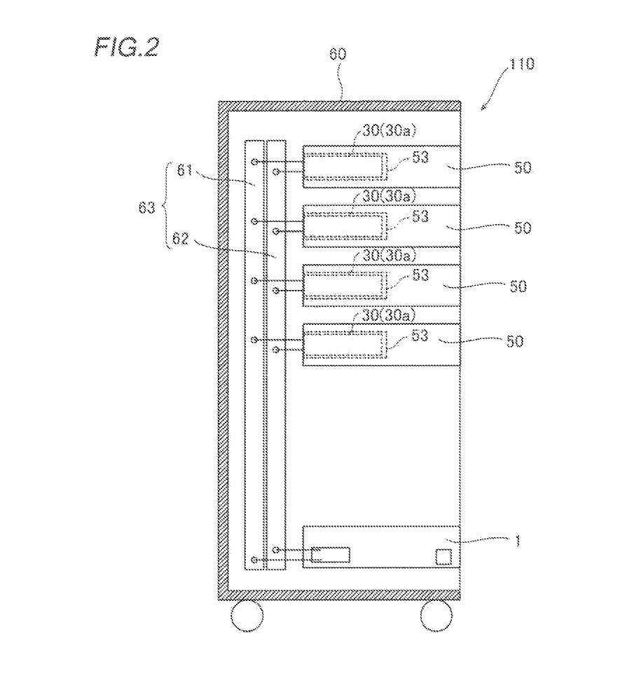

First, the schematic configuration of the DC power supply system 100 is described with reference to FIGS. 1 and 2. As shown in FIG. 1, the DC power supply system 100 includes a DC power supply 1 and the power supply relay units 30. The DC power supply system 100 is configured to convert AC power supplied from an AC power supply 200 into DC power and supply the DC power to a plurality of servers 50. The servers 50 are examples of a “load” in the claims.

The servers 50 each include a general AC server driven by converting input AC power into DC power. In a general AC server, a power supply unit (server-side power supply unit) (not shown) that converts AC power into DC power is provided. On the other hand, in the general (existing) AC server of each of the servers 50 according to the present embodiment, a server-side power supply unit that converts AC power into DC power is removed.

Furthermore, a DC power distribution device 201 is provided between the AC power supply 200 and the DC power supply system 100.

A plurality of sets (server systems 110) of the DC power supply 1, the power supply relay units 30, and the servers 50 are provided. The plurality of server systems 110 is connected in parallel to each other. That is, the DC power supply 1 is provided in each of the plurality of server systems 110. Thus, unlike the case where one DC power supply 1 is provided for the plurality of server systems 110, even if one of a plurality of DC power supplies 1 fails, it is possible to suppress stop of all the server systems 110.

(Configuration of DC Power Supply)

The DC power supply 1 includes a power supply unit 10 that converts AC power into DC power and a battery unit 20 that stores the DC power obtained by conversion by the power supply unit 10. The power supply unit 10 includes a power supply circuit 11. The power supply circuit 11 includes an AC-DC converter 12 and a DC-DC converter 13. The AC power supplied from the AC power supply 200 is converted into DC power by the AC-DC converter 12. The DC power obtained by conversion by the AC-DC converter 12 is converted into DC power having a predetermined voltage by the DC-DC converter 13. The DC power, the voltage of which has been converted into the predetermined voltage by the DC-DC converter 13, is supplied to the servers 50.

The battery unit 20 includes a battery circuit 21. The battery circuit 21 includes a battery 22 charged with DC power and a DC-DC converter 23 that bi-directionally conducts DC power. The battery 22 is connected in parallel to the power supply circuit 11 via the DC-DC converter 23 capable of bi-directionally conducting DC power. Furthermore, the battery 22 is charged with DC power by the power supply circuit 11 via the DC-DC converter 23, and supplies the charged DC power to the servers 50 via the DC-DC converter 23. That is, the DC power supply 1 normally supplies DC power from the power supply circuit 11 to the servers 50, and supplies DC power from the battery circuit 21 to the servers 50 when DC power is not supplied from the power supply circuit 11, such as in the event of a power failure.

As shown in FIG. 2, the DC power supply 1 and the plurality of servers 50 are disposed in a server rack 60. The DC power supply 1 is disposed in a lower portion of the server rack 60. The plurality of servers 50 is disposed above the DC power supply 1. In the server rack 60, a conductor 63 including a positive electrode conductor 61 and a negative electrode conductor 62 is provided. The power supply relay units 30 are electrically connected to the conductor 63. In addition, the plurality of servers 50 is connected in parallel to the conductor 63. The DC power output from the DC power supply 1 is supplied to the plurality of servers 50 via the conductor 63 and the power supply relay units 30.

(Detailed Configuration of Power Supply Relay Unit)

Next, the detailed configuration of one of the power supply relay units 30 according to the present embodiment is described with reference to FIGS. 2 to 5.

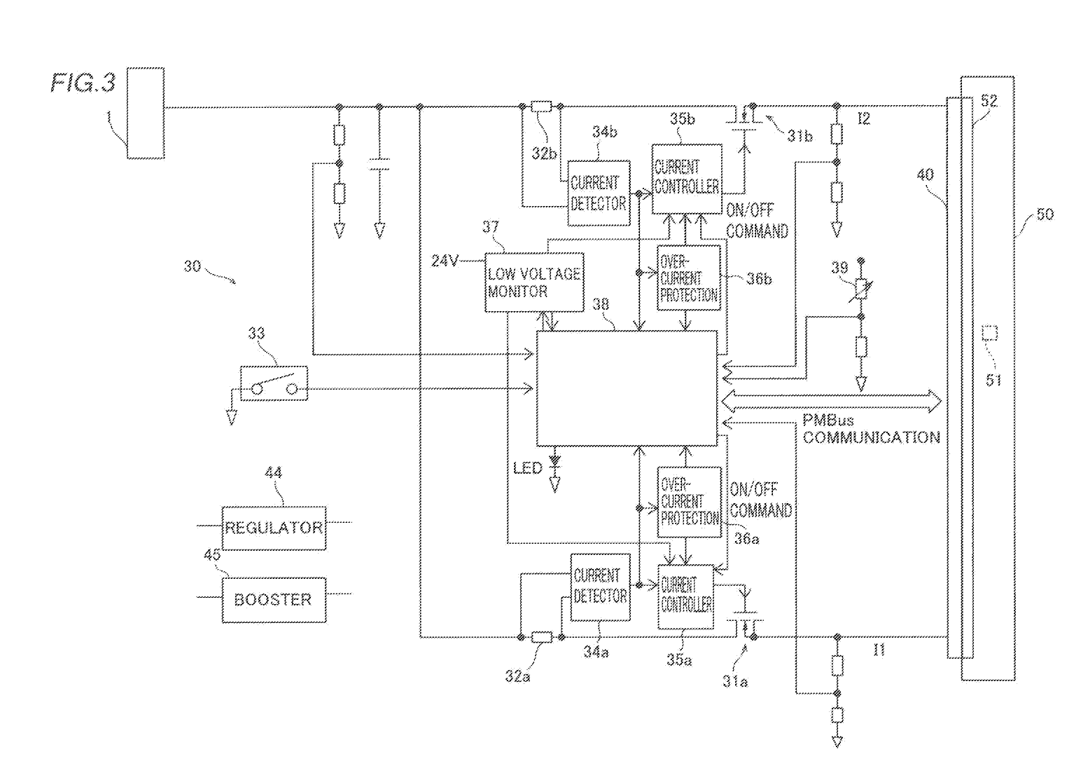

According to the present embodiment, as shown in FIG. 3, the power supply relay unit 30 includes a switch 31a. The switch 31a is configured to receive the DC power from the DC power supply 1 via a shunt resistor 32a. The switch 31a is configured to be turned on to supply a current I1 (2 A, 12 V, for example) to one of the servers 50 and activate a server-side controller 51 of the server 50. The switch 31a is an example of a “first switch” in the claims. The current I1 is an example of a “first current” in the claims. The server-side controller 51 is an example of a “load-side controller” in the claims.

The switch 31a includes an FET (Field Effect Transistor), for example. The shunt resistor 32a is connected to a drain of the switch 31a, and a connection 40 described later is connected to a source thereof. A current controller 35a described later is connected to a gate of the switch 31a. The connection 40 is an example of a “power supply relay unit-side connection” in the claims.

The power supply relay unit 30 further includes a switch 33. The switch 33 includes a mechanical switch, for example. The switch 33 is configured to be turned on to turn on the switch 31a. Specifically, after a signal indicating that the switch 33 has been turned on is input to a controller 38, a signal for turning on the switch 31a is output from the controller 38.

The power supply relay unit 30 further includes a switch 31b. The switch 31b is configured to receive the DC power from the DC power supply 1 via a shunt resistor 32b. The switch 31b is configured to, after the server-side controller 51 of the server 50 is activated, be turned on based on a request signal for requesting power supply from the server-side controller 51 of the server 50 to supply a current I2 (100 A, 12 V, for example) larger than the current I1 to the server 50 and drive the server 50. Specifically, after the request signal (a command based on the PMBus (registered trademark) standard) for requesting power supply from the server-side controller 51 of the server 50 is input to the controller 38, a signal for turning on the switch 31b is output from the controller 38. The switch 31b is an example of a “second switch” in the claims. The current I2 is an example of a “second current” in the claims. The PMBus is an example of a “predetermined standard” in the claims.

The switch 31b includes an FET (Field Effect Transistor), for example. The connection 40 described later is connected to a source of the switch 31b, and the shunt resistor 32b is connected to a drain thereof. A current controller 35b described later is connected to a gate of the switch 31b. The switch 31a and the switch 31b are connected in parallel to each other.

In addition, a current detector 34a is provided at both ends of the shunt resistor 32a. A current detector 34b is also provided at both ends of the shunt resistor 32b. The current detectors 34a and 34b are configured to detect a current (current value) that flows through the server 50. A signal from the current detector 34a is output to the current controller 35a, an overcurrent protection 36a, and the controller 38. A signal from the current detector 34b is output to the current controller 35b, an overcurrent protection 36b, and the controller 38.

On the output side of the current detector 34a, the current controller 35a is provided. The current controller 35a is configured to output a signal to the gate of the switch 31a. On the output side of the current detector 34b, the current controller 35b is provided. The current controller 35b is configured to output a signal to the gate of the switch 31b. The current controller 35a (current controller 35b) is configured to gently turn on the switch 31a (switch 31b). When the switch 31a (switch 31b) is abruptly turned on, the switch 31a (switch 31b) may be damaged due to a large inrush current for charging a load capacitor (not shown) on the server 50 side. Therefore, the switch 31a (switch 31b) is gently turned on.

Signals from the current detector 34a, the overcurrent protection 36a, the controller 38, and a low voltage monitor 37 are input to the current controller 35a. Signals from the current detector 34b, the overcurrent protection 36b, the controller 38, and the low voltage monitor 37 are input to the current controller 35b.

On the output side of the current detector 34a, the overcurrent protection 36a is provided. The signal from the overcurrent protection 36a is output to the current controller 35a and the controller 38. On the output side of the current detector 34b, the overcurrent protection 36b is provided. The signal from the overcurrent protection 36b is output to the current controller 35b and the controller 38. The overcurrent protection 36a and the overcurrent protection 36b are configured to suppress damages of the switch 31a and the switch 31b due to short-circuit currents when the output (sub output) of the switch 31a and the output (main output) of the switch 31b are short-circuited. When the overcurrent protection 36a and the overcurrent protection 36b are configured by software, there are cases where it is not possible to suppress damages of the switch 31a and the switch 31b, and hence the overcurrent protection 36a and the overcurrent protection 36b are configured by hardware.

The power supply relay unit 30 further includes the low voltage monitor 37. The signal from the controller 38 is input to the low voltage monitor 37. The signal from the low voltage monitor 37 is output to the current controller 35a, the current controller 35b, and the controller 38. The low voltage monitor 37 is configured to suppress damages of the switches 31a and 31b when a low voltage (24 V, for example) drops due to, for example, a failure of a booster 45 described later during operation of the power supply relay unit 30 (server 50).

The power supply relay unit 30 further includes the controller 38. The controller 38 is configured to control whether the switch 31a (switch 31b) is on or off so as to supply the DC power from the DC power supply 1 to the server 50. Specifically, the controller 38 transmits a signal to the current controller 35a, and controls whether the switch 31a is on or off via the current controller 35a. In addition, the controller 38 transmits a signal to the current controller 35b, and controls whether the switch 31b is on or off via the current controller 35b. The controller 38 includes a microcomputer, for example.

Signals from the current detectors 34a and 34b, the overcurrent protections 36a and 36b, the low voltage monitor 37, and the switch 33 are input to the controller 38. Information on the power of the shunt resistors 32a and 32b on the input side, information on the power of the switches 31a and 31b on the server 50 side, and an output from a thermistor 39 are input to the controller 38. In addition, a signal is output from the controller 38 to a light source (LED).

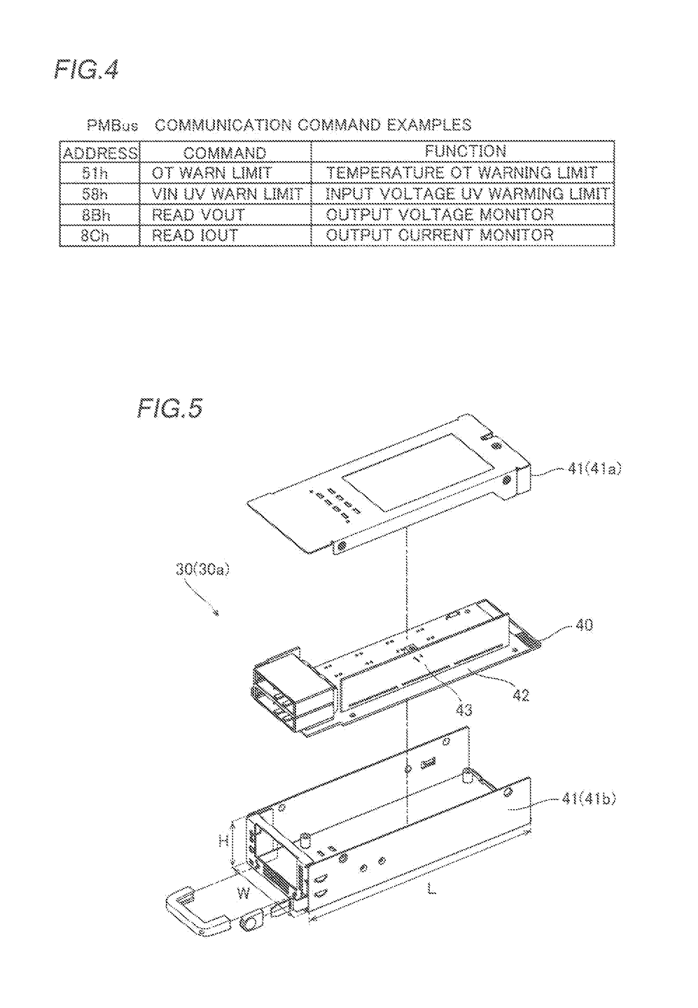

The controller 38 is configured to be capable of communicating with the server 50 based on the PMBus (registered trademark) standard. The PMBus is a standard for managing a power supply, and communication between devices is performed by exchanging commands. For example, as shown in FIG. 4, when the server 50 wants to know an output current value from the power supply relay unit 30, the server 50 transmits a READ IOUT command with an address of 8Ch to the power supply relay unit 30 such that the power supply relay unit 30 returns the output current value from the power supply relay unit 30 to the server 50.

According to the present embodiment, the controller 38 is configured to return preset dummy information on AC input power to the server 50 in response to a request signal from the server 50 for requesting information on the AC input power. Specifically, the controller 38 returns the preset dummy information on the AC input power to the server 50 in response to the request signal (command), based on the PMBus standard for managing a power supply, from the server 50 for requesting the information on the AC input power. For example, a request signal (a VIN UV WARN LIMIT command with a PMBus address of 58h, for example) for requesting information on the voltage value of AC power is transmitted from the server 50 to the controller 38 of the power supply relay unit 30. In response to this, the controller 38 of the power supply relay unit 30 returns dummy information that AC power of 200 V is input, for example, to the server 50.

It should be noted that the DC power supply 1 is connected to the power supply relay unit 30, and instead of AC power, DC power is actually input. However, when information that DC power is input is transmitted to the server 50, the server 50 stops because the server 50 does not obtain the requested information (appropriate information) on the AC input power. Therefore, the dummy information on the AC input power is returned from the controller 38 of the power supply relay unit 30 to the server 50 such that it is possible to suppress stop of the server 50.

The preset dummy information on the AC input power is stored in advance in a memory (not shown). The dummy information can be rewritten by a user.

According to the present embodiment, as shown in FIG. 3, the power supply relay unit 30 includes the connection 40. A general AC server includes a server-side connection 52 connectable to a power supply unit (server-side power supply unit) (not shown) that converts AC power into DC power. On the other hand, the server 50 according to the present embodiment does not include a server-side power supply unit (it is removed). The connection 40 of the power supply relay unit 30 is directly connected to the server-side connection 52. Specifically, the connection 40 is a card edge type connection (see FIG. 5). The term “card edge type” denotes an end of a printed circuit board with contacts to be inserted into a socket. The connection 40 of the power supply relay unit 30 is inserted into the server-side connection 52 of the server 50 to be directly connected to the server-side connection 52. The server-side connection 52 is an example of a “load-side connection” in the claims.

Specifically, as shown in FIG. 5, the power supply relay unit 30 includes housings 41 (an upper housing 41a, a lower housing 41b), a substrate 42 on which the switches 31a and 31b, the shunt resistors 32a and 32b, etc. are disposed, and a substrate 43 on which the controller 38 etc. are disposed. The connection 40 is provided at an end of the substrate 42 on which the switches 31a and 31b, the shunt resistors 32a and 32b, etc. are disposed.

As shown in FIG. 2, the server 50 includes a storage 53 capable of housing a server-side power supply unit that converts AC power into DC power. According to the present embodiment, the power supply relay unit 30 (power supply relay unit main body 30a) is disposed in the storage 53 of the server 50, which is capable of housing a server-side power supply unit, in a state where the connection 40 is directly connected to the server-side connection 52. That is, as shown in FIG. 5, the power supply relay unit 30 (power supply relay unit main body 30a) has a substantially rectangular parallelepiped shape, and has a size (a width W, a height H, a depth D) that can be housed in the storage 53. For example, the power supply relay unit 30 has substantially the same dimensions as those of a server-side power supply unit (not shown) of the server 50 or dimensions smaller than those of the server-side power supply unit.

As shown in FIG. 3, the power supply relay unit 30 includes a regulator 44. The regulator 44 is configured to step down (3.3 V, for example) an input voltage (12 V, for example). The power supply relay unit 30 further includes the booster 45. The booster 45 is configured to boost (24 V, for example) the input voltage (12 V, for example).

According to the present embodiment, as shown in FIG. 2, a plurality of power supply relay units 30 is provided so as to correspond to the plurality of servers 50. Specifically, in one server system 110, one DC power supply 1 and the plurality of servers 50 are provided. One (or more) power supply relay unit 30 is provided in each of the plurality of servers 50.

### Effects of Present Embodiment

According to the present embodiment, the following effects can be obtained.

According to the present embodiment, as hereinabove described, the controller 38 is configured to return the preset dummy information on the AC input power to the server 50 in response to the request signal from the server 50 for requesting the information on the AC input power. Thus, even when the server 50 requests the information on the AC input power from the power supply relay unit 30, the preset dummy information on the AC input power is returned from the power supply relay unit 30, and hence it is possible to suppress stop of the server 50 due to failure to obtain the appropriate information on the AC input power. Consequently, it is possible to suppress stop of the server 50 in the configuration in which the existing server 50 to which an alternating current is input is caused to function as the server 50 to which a direct current is input.

According to the present embodiment, as hereinabove described, the controller 38 is configured to return the preset dummy information on the AC input power to the server 50 in response to the request signal, based on the PMBus standard for managing a power supply, from the server 50 for requesting the information on the AC input power. Thus, when the server 50 operates based on the PMBus standard for managing a power supply, the existing server 50 to which an alternating current is input can be caused to function as the server 50 to which a direct current is input without separately, newly creating a configuration (software) for communicating (exchanging signals) between the server 50 and the power supply relay unit 30.

According to the present embodiment, as hereinabove described, the dummy information on the AC input power is the information on the voltage value of AC power. Thus, the information on the voltage value of AC power is returned to the server 50, and hence the server 50 determines that appropriate AC power is input. Consequently, it is possible to suppress stop of the server 50.

According to the present embodiment, as hereinabove described, the power supply relay unit 30 includes the connection 40 directly connected to the server-side connection 52 included in the server 50 and connectable to a server-side power supply unit that converts AC power into DC power. Thus, instead of the server-side power supply unit that converts AC power into DC power, the power supply relay unit 30 can be connected, and hence the power supply relay unit 30 can receive the request signal (a signal for making a request when the server 50 is driven) from the server 50, which the server-side power supply unit would receive if the server-side power supply unit was connected to the server-side connection 52.

According to the present embodiment, as hereinabove described, the power supply relay unit main body 30a is disposed in the storage 53 capable of housing a server-side power supply unit of the server 50 in a state where the connection 40 is directly connected to the server-side connection 52. Thus, the power supply relay unit 30 is disposed in the storage 53 capable of housing a server-side power supply unit and provided in advance in the server 50, and hence it is not necessary to separately provide a space for disposing the power supply relay unit 30. Consequently, it is possible to suppress an increase in the size of the system including the power supply relay units 30 and the servers 50.

According to the present embodiment, as hereinabove described, the power supply relay unit 30 includes the switch 31a turned on to supply the current I1 to the server 50 and activate the server-side controller 51 of the server 50, and the switch 31b turned on based on the request signal for requesting power supply from the server-side controller 51 of the server 50, after the server-side controller 51 of the server 50 is activated, to supply the current I2 larger than the current I1 to the server 50 and drive the server 50. Thus, after the server-side controller 51 of the server 50 is activated by the current I1, preparation of the server 50 is completed, and thereafter the server 50 can be driven by the current I2. Therefore, it is possible to suppress driving of the server 50 in a state where preparation of the server 50 is not completed.

According to the present embodiment, as hereinabove described, the plurality of power supply relay units 30 is provided so as to correspond to the plurality of servers 50. Thus, the dummy information on the AC input power can be returned from each of the plurality of power supply relay units 30 in response to the request signal from each of the plurality of servers 50.

[Modifications]

The embodiment disclosed this time must be considered as illustrative in all points and not restrictive. The range of the present invention is not shown by the above description of the embodiment but limited by the scope of claims for patent, and all modifications within the meaning and range equivalent to the scope of claims for patent are further included.

For example, while the example in which the information on the AC input power is transmitted from the controller to the server based on the PMBus standard has been shown in the aforementioned embodiment, the present invention is not restricted to this. For example, the information on the AC input power may be transmitted from the controller to the server based on a standard other than the PMBus standard.

While the example in which the information (dummy information) on the AC input power is the information on the voltage value of AC power has been shown in the aforementioned embodiment, the present invention is not restricted to this. According to the present invention, the information (dummy information) on the AC input power may be information (such as information on the current value) other than the information on the voltage value of AC power.

While the example in which the present invention is applied to the server as a load has been shown in the aforementioned embodiment, the present invention is not restricted to this. For example, the present invention may be applied to a load other than the server.

While the example in which the power supply relay unit is directly connected to the server by the connection has been shown in the aforementioned embodiment, the present invention is not restricted to this. For example, the power supply relay unit may be connected to the server via a cable.

While the example in which the power supply relay unit is housed in the storage capable of housing a server-side power supply unit provided in an existing AC server has been shown in the aforementioned embodiment, the present invention is not restricted to this. For example, the power supply relay unit may be disposed separately from the server.

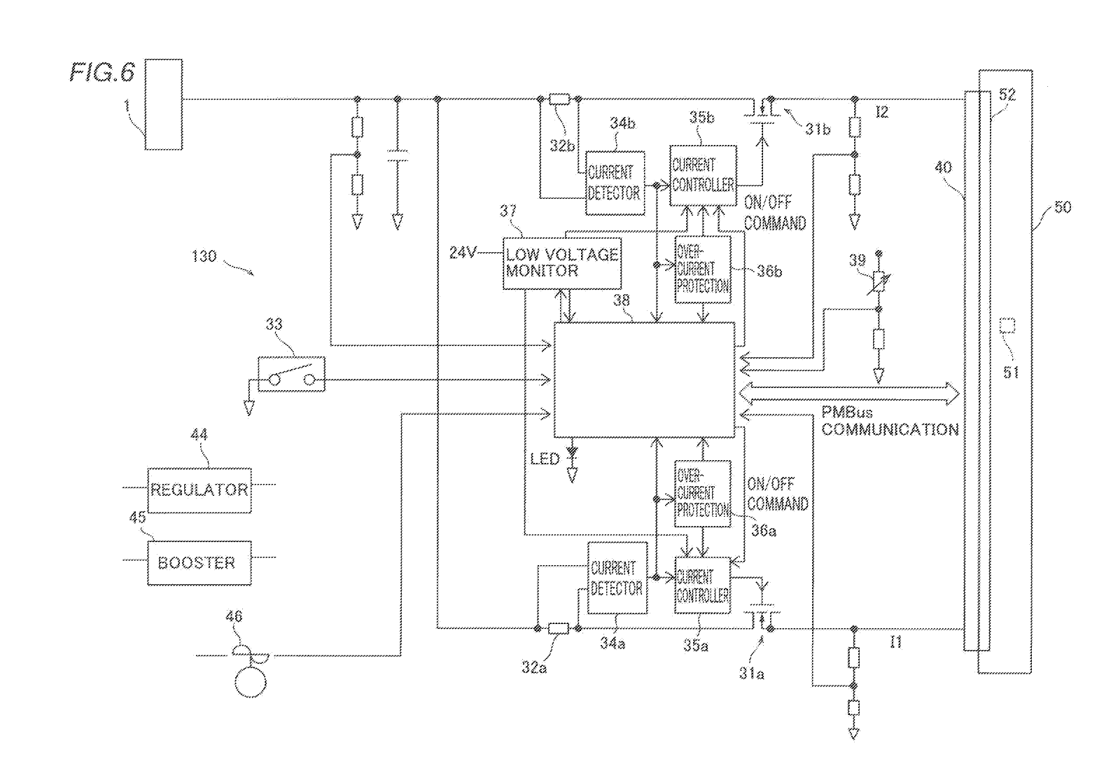

While the example in which the power supply relay unit does not include a cooling fan has been shown in the aforementioned embodiment, the present invention is not restricted to this. For example, as in a power supply relay unit 130 according to a modification shown in FIG. 6, a cooling fan 46 may be provided in the power supply relay unit 130. The cooling fan 46 is connected to a controller 38.

What is claimed is:

1. A power supply relay unit provided between a DC power supply including a power supply unit that converts AC power into DC power and a battery unit that stores the DC power obtained through the power supply unit, and a load, comprising:
a switch to which the DC power from the DC power supply is adapted to be input; and
a controller that controls whether the switch is on or off adapted to supply the DC power from the DC power supply to the load,
wherein the controller is configured to return preset dummy information about AC input power to the load in response to a request signal from the load for requesting information on the AC input power.

2. The power supply relay unit according to claim 1, wherein the controller is configured to return the preset dummy information about the AC input power to the load in response to the request signal, based on a predetermined standard for managing the power supply, from the load for requesting the information on the AC input power.

3. The power supply relay unit according to claim 1, wherein the dummy information about the AC input power is information on a voltage value of the AC power.

4. The power supply relay unit according to claim 1, further comprising a power supply relay unit-side connection adapted to be directly connected to a load-side connection included in the load and connectable to a load-side power supply unit that converts AC power into DC power.

5. The power supply relay unit according to claim 4, wherein the power supply relay unit-side connection is adapted to be directly connected to the load-side connection included in a server as the load and connectable to the load-side power supply unit.

6. The power supply relay unit according to claim 4, further comprising a power supply relay unit main body,
wherein the power supply relay unit main body is adapted to be disposed in a storage capable of housing the load-side power supply unit of the load in a state where the power supply relay unit-side connection is directly connected to the load-side connection.

7. The power supply relay unit according to claim 1, wherein the switch includes a first switch adapted to be turned on to supply a first current to the load and activate a load-side controller of the load, and a second switch adapted to be turned on based on a request signal for requesting power supply from the load-side controller of the load, after the load-side controller of the load is activated, to supply a second current larger than the first current to the load and drive the load.

8. The power supply relay unit according to claim 1, wherein one power supply relay unit is provided to correspond to one load.
